(19) United States
(12) Patent Application Publication
(10) Pub. No.: US 2022/0288623 A1
(43) Pub. Date: Sep. 15, 2022

(54) COATING HEAD

(71) Applicant: KABUSHIKI KAISHA TOSHIBA, Tokyo (JP)

(72) Inventors: Hiroki TASHIRO, Yokohama (JP); Hideaki MORISHIMA, Ichikawa (JP); Hironori TAKATSUKA, Yokohama (JP)

(73) Assignee: KABUSHIKI KAISHA TOSHIBA, Tokyo (JP)

(21) Appl. No.: 17/447,466

(22) Filed: Sep. 13, 2021

(30) Foreign Application Priority Data
Mar. 15, 2021 (JP) 2021-041475

(51) Int. Cl. B05C 5/02

(52) U.S. Cl. CPC B05C 5/0254

(57) ABSTRACT

According to an embodiment, a coating head includes a head main body, a first manifold, a first slit, a second manifold, and a second slit. Inside the head main body, the first slit is formed adjacent to the first manifold on a front side, and the second manifold is formed adjacent to the first slit on the front side. The second slit is formed adjacent to the second manifold on the front side, and forms an ejection port to eject a coating liquid from the second manifold to the outside. A dimension of the second slit along a height direction intersecting a front-back direction is larger than that of the first slit along the height direction.

### CROSS-REFERENCE TO RELATED APPLICATIONS

This application is based upon and claims the benefit of priority from Japanese Patent Application No. 2021-041475, filed Mar. 15, 2021; the entire contents of which are incorporated herein by reference.

### FIELD

Embodiments described herein relate generally to a coating head.

### BACKGROUND

A coating head such as a slot die is used for forming a coated body with a coating liquid applied to a surface of a substrate. In such a coating head, a manifold is formed inside a head main body, and a slit is formed adjacent to the manifold on a front side of the coating head. Then, the slit forms an ejection port for ejecting the coating liquid from the manifold to the outside toward the front side. In the formation of the coated body, the coating liquid ejected from the slit is applied to the surface of the substrate.

In a coating head as described above, it is required that the coating liquid be uniformly distributed in a width direction intersecting (orthogonal to or approximately orthogonal to) a front-back direction, and an ejection amount of the coating liquid from the ejection port become uniform regardless of a position in the width direction. In addition, it is required that deformation of the head main body be suppressed at the ejection port of the coating liquid and its vicinity.

### BRIEF DESCRIPTION OF THE DRAWINGS

FIG. 1 is a perspective view schematically showing a coating head according to a first embodiment.

FIG. 2 is a perspective view schematically showing the coating head according to the first embodiment in a state where two blocks and a shim plate are separated from one another.

FIG. 3 is a perspective view schematically showing the coating head according to the first embodiment in a state where one of the two blocks is separated from the other one of the two blocks and the shim plate.

FIG. 4 is a perspective view schematically showing one of the two blocks and the shim plate of the coating head according to the first embodiment in a partially cross-sectioned manner.

FIG. 5 is a perspective view schematically showing one of two blocks and a shim plate of a coating head according to a modification.

### DETAILED DESCRIPTION

According to an embodiment, a coating head includes a head main body, a first manifold, a first slit, a second manifold, and a second slit. The first manifold is formed inside a head main body, and the first slit is formed adjacent to the first manifold on a front side in an inner portion of the head main body. The second manifold is formed adjacent to the first slit on the front side in the inner portion of the head main body, and a coating liquid flows into the second manifold from the first manifold through the first slit. The second slit is formed adjacent to the second manifold on the front side in the head main body, and forms an ejection port to eject the coating liquid from the second manifold to the outside toward the front side. A dimension of the second slit along a height direction intersecting a front-back direction is larger than that of the first slit along the height direction.

Hereinafter, an embodiment will be described with reference to the drawings.

### First Embodiment

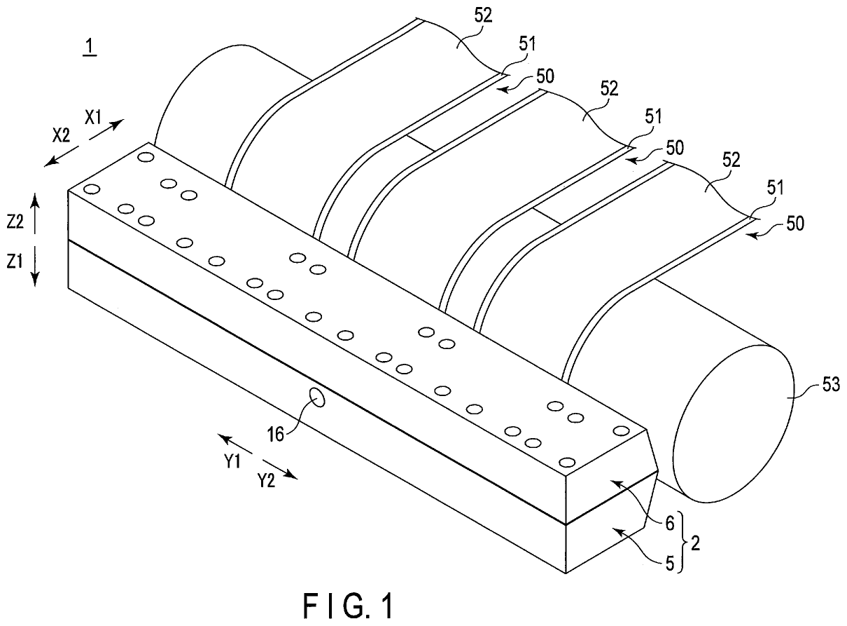

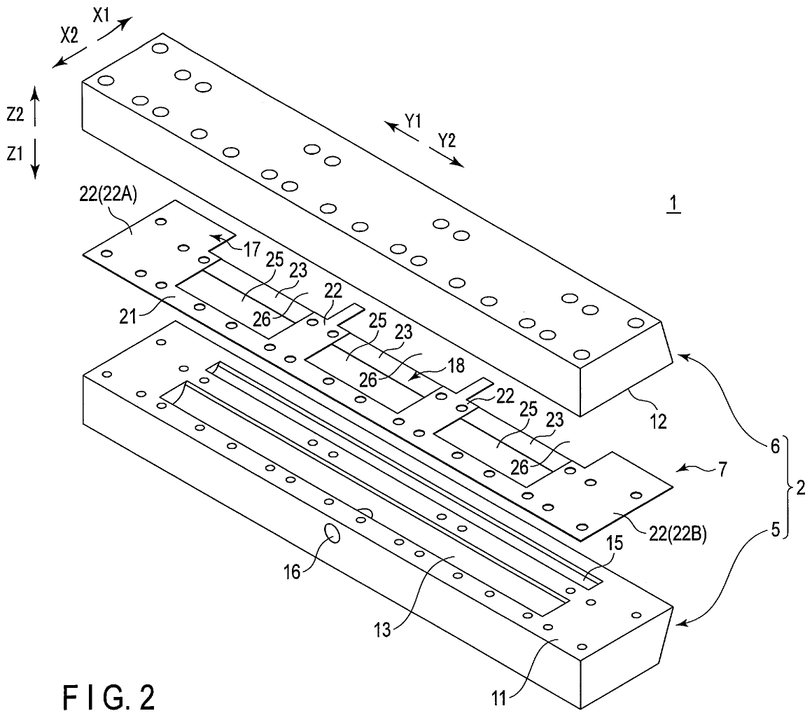

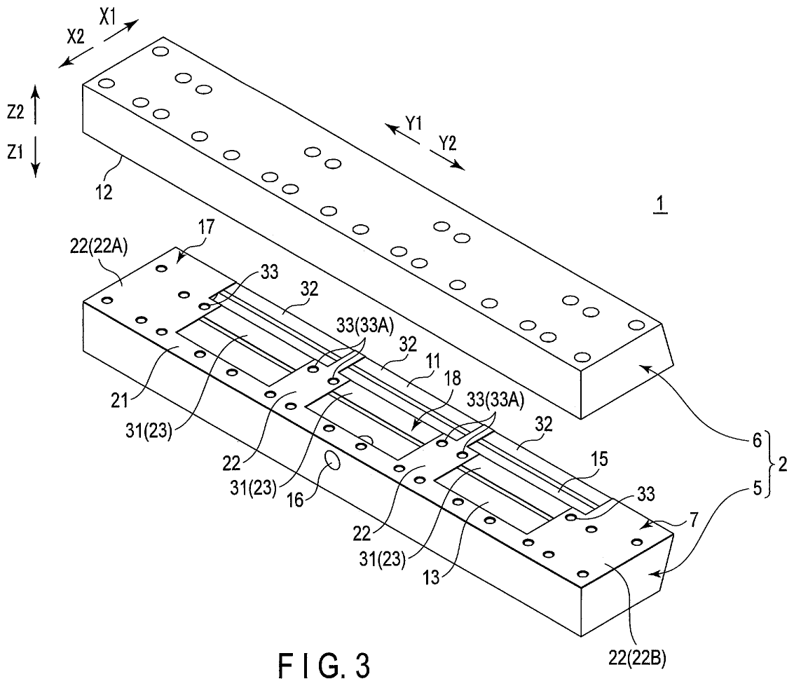

FIGS. 1 to 3 show a coating head 1 according to a first embodiment. In the present embodiment, the coating head 1 is, for example, a slot die. As shown in FIGS. 1 to 3, the coating head 1 includes a head main body 2, and the head main body 2 includes two blocks 5 and 6. In addition, the coating head 1 includes a shim plate 7. Each of the blocks 5 and 6 and the shim plate 7 is made of, for example, a metal. In FIG. 2, the block (a first block) 5, the block (a second block) 6, and the shim plate 7 are shown in a state of being separated from one another. In addition, in FIG. 3, the block 6 is separated from the block 5 and the shim plate 7.

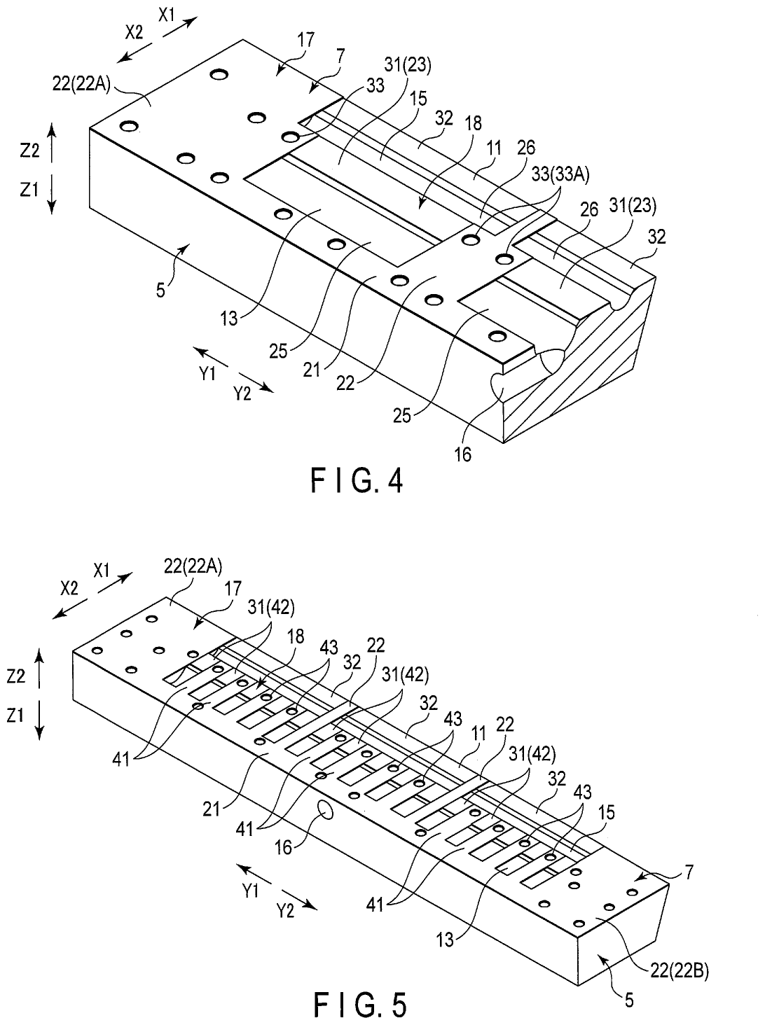

In the coating head 1, a front-back direction (the direction indicated by arrows X1 and X2), a width direction (the direction indicated by arrows Y1 and Y2) intersecting (orthogonal to or approximately orthogonal to) the front-back direction, a height direction (the direction indicated by arrows Z1 and Z2) intersecting (orthogonal to or approximately orthogonal to) both the front-back direction and the width direction, are defined. In the coating head 1 (head main body 2), a dimension along the width direction is larger than each of a dimension along the front-back direction and a dimension along the height direction. In addition, FIG. 4 shows a part of the block 5 and the shim plate 7, and in a part of FIG. 4, showing a cross section cutting the block 5 and the shim plate 7 on a cutting surface orthogonal to or approximately orthogonal to the width direction of the coating head 1.

As shown in FIGS. 1 to 4, etc., each of the blocks 5 and 6 is extended from one end to the other end of the coating head 1 in the width direction of the coating head 1, and is extended from a front end to a back end of the coating head 1 in the front-back direction of the coating head 1. Thus, in each of the blocks 5 and 6, a dimension along the width direction of the coating head 1 is larger than each of a dimension along the front-back direction of the coating head 1 and a dimension along the height direction of the coating head 1.

The block (second block) 6 is attached to the block (first block) 5 from one side of the height direction. In an example, the height direction of the coating head 1 (head main body 2) coincides with or approximately coincides with the vertical direction, and the block 6 is attached to the block 5 from the vertically upper side. The shim plate 7 is sandwiched between the blocks 5 and 6 in the height direction of the coating head 1. In the shim plate 7, a plate thickness direction is defined. The shim plate 7 is arranged between the blocks 5 and 6 in a state where the plate thickness direction coincides with or approximately coincides with the height direction of the coating head 1.

The block 5 includes a surface (a first surface) 11 facing a side on which the block 6 is located in the height direction of the coating head 1, and the block 6 includes a surface (a second surface) 12 facing a side on which the block 5 is located in the height direction of the coating head 1. Manifolds 13 and 15 are formed inside the head main body 2. In the present embodiment, the manifolds 13 and 15 are formed on the surface 11 of the block 5. On the surface 11, each of the manifolds 13 and 15 is recessed toward a side opposite to the side on which the block 6 is located in the height direction.

In each of the manifolds 13 and 15, a dimension along the width direction of the coating head 1 is larger than that along the front-back direction of the coating head 1. Thus, each of the manifolds 13 and 15 is formed in a long groove shape in which the dimension along the width direction of the coating head 1 is large. In the block 5, each of the manifolds 13 and 15 is extended from one end portion to the other end portion in the width direction of the coating head 1.

On the surface 11 of the block 5, the manifolds 13 and 15 are arranged separately from each other in the front-back direction of the coating head 1. In the present embodiment, the manifold (a first manifold) 13 is formed separately to a back side (an arrow X2 side) with respect to the manifold (a second manifold) 15. In addition, a recess amount of the manifold 15 is smaller than that of the manifold 13, and a dimension (depth) of the manifold along the height direction of the coating head 1 is smaller than that of the manifold 13 along the height direction of the coating head 1.

A dimension (a groove width) of the manifold 15 along the front-back direction of the coating head 1 is smaller than that of the manifold 13 along the front-back direction of the coating head 1. In an example of FIGS. 2 to 4, etc., each of the manifolds 13 and 15 becomes a semicircular shape or an approximately semicircular shape at a cross section orthogonal to or approximately orthogonal to the width direction of the coating head 1. In each of the manifolds 13 and 15, at a cross section orthogonal to or approximately orthogonal to the width direction of the coating head 1, a bottom surface may be arc-shaped or approximately arc-shaped, and may be formed in a curved surface shape.

In addition, an inflow path 16 is formed inside the block (first block) 5. One end of the inflow path 16 communicates with the manifold 13. The other end of the inflow path 16 opens to the outside of the coating head 1, i.e., opens toward the back side. In the coating head 1, an end of the inflow path 16 on a side opposite to a side connected to the manifold 13 serves as an inflow port of the coating liquid from the outside of the coating head 1.

The shim plate 7 includes plate thickness parts 17 and 18. The plate thickness part (a first plate thickness part) 17 becomes a first plate thickness in a plate thickness direction (the height direction of the coating head 1). The plate thickness part (a second plate thickness part) 18 becomes a second plate thickness thinner than the first plate thickness in the plate thickness direction (the height direction of the coating head 1). In the shim plate 7, a surface facing the side on which the block 5 is located is formed in a state whereby its entirety is located on the same or approximately the same plane. Then, in the shim plate 7, a surface facing the side on which the block 6 is located is formed in a state where the plate thickness part 18 is recessed to the side on which the block 5 is located with respect to the plate thickness part 17. In the coating head 1, a gap is not formed or is rarely formed between each of the blocks 5 and 6 and the plate thickness part 17. Then, between the block 5 and the plate thickness part 18 also, a gap is not formed or is rarely formed. However, a gap is formed between the block 6 and the plate thickness part 18.

The plate thickness part (first plate thickness part) 17 of the shim plate 7 includes an extending plate part 21, and four protruding plate parts 22 in the present embodiment. The extending plate part 21 is extended from one end to the other end in the width direction of the coating head 1. In addition, in the coating head 1, the extending plate part 21 is located on the back side with respect to the manifold 13, and forms a back end of the coating head 1. Each of the protruding plate parts 22 protrudes from the extending plate part 21 toward the front side of the coating head 1. A protruding end of each of the protruding plate parts 22 forms a front end of the coating head 1.

The protruding plate parts 22 are arranged separately from one another in the width direction of the coating head 1. In the coating head 1, a protruding plate part 22A, which is one of the protruding plate parts 22, forms an end on one side of the width direction. Then, in the coating head 1, a protruding plate part 22B, which is one of the protruding plate parts 22 different from the protruding plate part 22A, forms an end on a side opposite to the protruding plate part 22A in the width direction. In addition, the protruding plate parts 22 other than the protruding plate parts 22A and 22B are arranged between the protruding plate parts 22A and 22B in the width direction of the coating head 1.

The plate thickness part (second plate thickness part) 18 of the shim plate 7 includes three relay plate parts 23 in the present embodiment. Two protruding plate parts 22 adjacent in the width direction of the coating head 1 are relayed by a corresponding one of the relay plate parts 23. Accordingly, each of the relay plate parts 23 is extended between two corresponding protruding plate parts 22 along the width direction of the coating head 1. In addition, each of the relay plate parts 23 is arranged apart from the extending plate part 21 to the front side (an arrow X1 side) of the coating head 1, and also apart from the protruding end of each of the protruding plate parts 22 to the back side of the coating head 1.

Each of the relay plate parts 23 is located between the manifolds 13 and 15 in the front-back direction of the coating head 1. Then, each of the relay plate parts 23 is adjacent to both the manifold (first manifold) 13 on the front side of the coating head 1 and the manifold (second manifold) 15 on the back side of the coating head 1. Each of the relay plate parts 23 is a part of the plate thickness part 18. Thus, a gap is not formed or is rarely formed between each of the relay plate parts 23 and the surface 11 of the block 5. Then, a gap is formed between each of the relay plate parts 23 and the surface 12 of the block 6.

In addition, in the shim plate 7, a hole 25 is formed between each of the relay plate parts 23 and the extending plate part 21, and three holes 25 are formed in the present embodiment. Each of the holes 25 penetrates the shim plate 7 along the plate thickness direction (the height direction of the coating head 1). In each of the holes 25, an edge is formed by the extending plate part 21, corresponding two of the protruding plate parts 22, and a corresponding one of the relay plate parts 23. In the coating head 1, the hole 25 is not shifted or is rarely shifted from the manifold 13 in the front-back direction.

In addition, in the shim plate 7, three cuts 26 are formed in the present embodiment, each of which is adjacent to a side opposite to the hole 25 with respect to a corresponding one of the relay plate parts 23. Each of the cuts penetrates the shim plate 7 along the plate thickness direction (the height direction of the coating head 1). In each of the cuts 26, an edge is formed by corresponding two of the protruding plate parts 22 and a corresponding one of the relay plate parts 23. In the coating head 1, each of the cuts 26 opens toward the front side between the protruding ends of the corresponding two of the protruding plate parts 22.

Since the shim plate 7 has the above-described configuration, inside the head main body 2, three slits (first slits) 31 are formed, in addition to the manifolds 13 and 15, between the blocks 5 and 6 in the present embodiment. In the coating head 1, each of the slits 31 is formed adjacent to the manifold (first manifold) 13 on the front side, and the manifold 15 is formed adjacent to each of the slits 31 on the front side. Thus, inside the head main body 2, the manifold 15 communicates with the manifold 13 via the slit 31 therebetween.

Each of the slits 31 is formed by a gap between a corresponding one of the relay plate parts 23 and the surface 12 of the block 6. Thus, in each of the slits 31, the plate thickness part 18 of the shim plate 7 is extended between the blocks 5 and 6. In the present embodiment, the three slits 31 are provided in a state of being arranged along the width direction of the coating head 1. However, the three slits 31 are arranged apart from one another in the width direction of the coating head 1. Then, two slits 31 adjacent to each other in the width direction of the coating head 1 are partitioned by a corresponding one of the protruding plate parts 22 of the plate thickness part 17.

Further, since the shim plate 7 has the above-described configuration, in the head main body 2, three slits (second slits) 32 are formed between the blocks 5 and 6, in addition to the manifolds 13 and 15 and slits 31, in the present embodiment. In the coating head 1, each of the slits 32 is formed adjacent to the manifold (second manifold) 15 on the front side. In each of the slits 32, an end on a side opposite to a side connected to the manifold 15 opens to the outside of the coating head 1, i.e., opens toward the front side. Then, in the coating head 1, in each of the slits 32, the end on the side opposite to that connected to the manifold 15 serves as an ejection port configured to eject the coating liquid from the coating head 1 to the outside.

Each of the slits 32 is formed by a gap between the surface 11 of the block 5 and the surface 12 of the block 6. Thus, in each of the slits 32, the shim plate 7 is not arranged between the blocks 5 and 6. In the present embodiment, the three slits 32 are provided in a state of being arranged along the width direction of the coating head 1. However, the three slits 32 are arranged apart from one another in the width direction of the coating head 1. Then, two slits 32 adjacent to each other in the width direction of the coating head 1 are partitioned by a corresponding one of the protruding plate parts 22 of the plate thickness part 17.

Here, in each of the slits 31, the plate thickness part (second thickness part) 18 of the shim plate 7 is extended between the blocks 5 and 6, whereas in each of the slits 32, the shim plate 7 is not arranged between the blocks 5 and 6. Thus, in the present embodiment, a dimension of each of the slits (second slits) 32 along the height direction of the coating head 1 is larger than that of each of the slits (first slits) 31 along the height direction of the coating head 1. That is, a dimension of each of the slits 31 along the height direction of the coating head 1 is smaller than that of each of the slits 32 along the height direction of the coating head 1. In addition, in the present embodiment, a dimension of each of the slits (first slits) 31 along the width direction of the coating head 1 is smaller than that of each of the slits (second slits) 32 along the width direction of the coating head 1.

In the present embodiment, the block 6 is attached to the block 5 by fastening the block 6 to the block 5 via a plurality of fastening members (not shown). In the head main body 2, one or more fastening parts 33 are formed between the manifolds 13 and 15, and a plurality of fastening parts 33 are formed in the present embodiment. Each of the fastening parts 33 is one of fastening positions where the blocks 5 and 6 are fastened. At each of the fastening parts 33, a corresponding one of the protruding plate parts 22 of the shim plate 7 is sandwiched between the blocks 5 and 6. Each of the fastening parts 33 is located between the manifolds 13 and 15 in the front-back direction of the coating head 1. Further, each of the fastening parts 33 is not shifted or is rarely shifted with respect to the slit (first slit) 31 in the front-back direction of the coating head 1.

In the present embodiment, each of the fastening parts 33 is formed adjacent to corresponding one or more of the slits 31 in the width direction of the coating head 1. Of the fastening parts 33, those other than the two at both ends in the width direction of the coating head 1 are referred to as “fastening parts 33A”. Each of the fastening parts 33A is formed between two slits 31 adjacent to each other in the width direction of the coating head 1. In each of the fastening parts 33, the plate thickness part (first plate thickness part) 17 of the shim plate 7 is extended between the blocks 5 and 6. Thus, in each of the fastening parts 33, a gap is not formed or is rarely formed between each of the blocks 5 and 6 and the shim plate 7.

In the present embodiment, since the coating head 1 is formed as described above, the flow paths of the coating liquid are formed by the manifolds 13 and 15, the inflow path 16, and the slits 31 and 32. In the flow path of the coating liquid formed in the coating head 1, the inflow path 16, the manifold (first manifold) 13, the slit (first slit) 31, the manifold (second manifold) 15, and the slit (second slit) 32 are arranged in this order from an upstream side to a downstream side. The coating liquid flows into the manifold 13 through the inflow path 16, and then from the manifold 13 into the manifold 15 through any one of the slits 31. Then, the coating liquid is ejected from the manifold 15 to the outside of the coating head 1 toward the front side through an ejection port of any one of the slits 32. In the coating head 1, the front side is an ejection direction of the coating liquid from the ejection port.

As shown in FIG. 1, etc., the coating head 1 is used for forming a coated body 50. In forming the coated body 50, the coating head 1 is used to apply a coating liquid 52 to a surface of a substrate (base member) 51. At this time, the substrate 51 and the coated body 50 in which the coating liquid 52 is applied to the substrate 51 are conveyed by a conveying part formed of a guide roller 53, etc. The coating head 1 ejects the coating liquid 52 toward the substrate 51 from the ejection port of each of the slits (second slits) 32, and applies the coating liquid 52 to the surface of the substrate 51.

In an example, an electrode sheet serving as a battery electrode (a positive electrode or a negative electrode) is formed as the coated body 50. In this case, a current collector such as an aluminum foil or an aluminum alloy foil is used as the substrate 51. Then, a slurry in which an active material is suspended is applied, as the coating liquid 52, to the surface of the substrate 51. As a result, an active material-containing layer is formed on the surface of the current collector. Further, in one example of FIG. 1, etc., the substrate to which the coating liquid 52 is applied is different for each slit 32. Thus, the coating liquid 52 can be simultaneously applied to the same number of substrates 51 as the slits 32, and in one example of FIG. 1, etc., the coating liquid 52 can be simultaneously applied to the three substrates 51.

In the coating head 1 of the present embodiment, two manifolds 13 and 15 are provided inside the head main body 2, and the coating liquid flows into the manifold 15 from the manifold 13 through any one of the slits 31. By providing the two manifolds 13 and 15 and the slits 31 between the manifolds 13 and 15, the coating liquid can easily reach the entirety in the width direction of the coating head 1 in the flow path of the coating liquid formed in the coating head 1.

Further, in the present embodiment, the dimension of each of the slits 31 along the height direction of the coating head 1 is smaller than that of each of the slits 32 along the height direction of the coating head 1. By reducing the dimension of each of the slits 31 along the height direction of the coating head 1, the coating liquid easily flows in the width direction of the coating head 1 in the manifold 13, and can more easily reach over the entirety in the width direction of the coating head 1 in the flow path of the coating liquid formed in the coating head 1. Therefore, in the present embodiment, the coating liquid is uniformly distributed in the width direction of the coating head 1 in the flow path formed of the manifolds 13 and 15 and the slits 31 and 32, etc.

Through the coating liquid being uniformly distributed in the width direction of the coating head 1 in the flow path, an ejection amount of the coating liquid from the ejection port becomes uniform regardless of the position in the width direction in the coating head 1. That is, variation in the ejection amount among the ejection ports of the plurality of slits 32 is reduced, and the ejection amounts of the ejection ports of the plurality of slits 32 become uniform with respect to one another. As a result, when the coating liquid 52 is simultaneously applied to the plurality of substrates 51 as shown in FIG. 1, etc., the amount of the coating liquid 52 to be applied becomes uniform among the plurality of substrates 51. Accordingly, for example, when a plurality of electrode sheets are simultaneously formed as the coated bodies 50, basis weights of the active material-containing layers formed by the applied coating liquid become uniform among the plurality of electrode sheets.

Further, in the present embodiment, the dimension of each of the slits 32 along the height direction of the coating head 1 is larger than that of each of the slits 31 along the height direction of the coating head 1. By increasing the dimension of each of the slits 32 along the height direction of the coating head 1, a pressure acting on the head main body 2 from the coating liquid becomes small at the ejection port formed in each of the slits 32 and its vicinity. As a result, deformation of the head main body 2 is suppressed in the ejection port and its vicinity.

In addition, in the present embodiment, each of the fastening parts 33 is formed between the manifolds 13 and 15 in the front-back direction of the coating head 1. Accordingly, the fastening part 33 for fastening the blocks 5 and 6 is formed at a position where it is not shifted or is rarely shifted from the slit 31 in the front-back direction of the coating head 1. Here, since the dimension of each of the slits 31 along the height direction of the coating head 1 is small as described above, the pressure acting on the head main body 2 from the coating liquid becomes high in each of the slits 31 and its vicinity. In the present embodiment, since the fastening part 33 is formed at the above-described position, the blocks 5 and 6 are fastened in a region where the pressure acting on the head main body 2 from the coating liquid becomes high or its vicinity. Thereby, in each of the slits 31 and its vicinity, even if the pressure acting on the head main body 2 from the coating liquid increases, the deformation of the head main body 2 is appropriately suppressed.

Further, in the present embodiment, each of the fastening parts 33 is formed adjacent to the corresponding one or more of the slits 31 in the width direction of the coating head 1. Then, each of the fastening parts 33A is formed between two slits 31 adjacent to each other in the width direction of the coating head 1. As a result, the fastening part 33 is formed in the vicinity of each of the slits 31, and the blocks 5 and 6 are appropriately fastened in the region where the pressure acting on the head main body 2 from the coating liquid becomes high or its vicinity.

In addition, the dimension of the manifold (second manifold) 15 along the front-back direction of the coating head 1 is smaller than that of the manifold (first manifold) 13 along the front-back direction of the coating head 1. Thus, a distance from the fastening part 33 to the ejection port of the slit 32 along the front-back direction of the coating head 1 becomes small. Through the distance from the fastening part 33 to the ejection port becoming small, deformation of the head main body 2 at the ejection port and its vicinity is more appropriately suppressed.

Further, in the present embodiment, the dimension of each of the slits (first slits) 31 along the width direction of the coating head 1 is smaller than that of each of the slits (second slits) 32 along the width direction of the coating head 1. Through the dimension of each of the slits 31 along the width direction becoming small, the fastening part 33 can be easily formed between the manifolds 13 and 15. In addition, as the dimension of each of the slits 31 along the width direction diminishes, the coating liquid flows more easily in the width direction of the coating head 1 in the manifold 13, and thereby, in the flow path of the coating liquid formed in the coating head 1, the coating liquid more easily reaches over the entirety in the width direction of the coating head 1.

Further, in the present embodiment, the plate thickness part (first plate thickness part) 17 and the plate thickness part (second plate thickness part) 18 thinner than the plate thickness part 17 are formed in the shim plate 7. Then, in each of the slits 31, the plate thickness part 18 is extended between the blocks 5 and 6 and, in each of the slits 32, the shim plate 7 is not arranged between the blocks 5 and 6. Then, in each of the fastening parts 33, the plate thickness part 17 is extended between the blocks 5 and 6. With such a configuration, the above-described slits 31 and 32 can be easily formed between the blocks 5 and 6.

(Modification)

Also in a modification shown in FIG. 5, the shim plate 7 includes the plate thickness part (first plate thickness part) 17 which has the first plate thickness and the plate thickness part (second plate thickness part) 18 which has the second plate thickness thinner than the first plate thickness. The plate thickness part 17 includes the extending plate part 21 and the four protruding plate parts 22, and the three slits (second slits) 32 are formed in the head main body 2. Then, two slits 32 adjacent to each other in the width direction of the coating head 1 are partitioned by a corresponding one of the protruding plate parts 22 of the plate thickness part 17. However, in the present modification, the plate thickness part 17 of the shim plate 7 includes a plurality of convex plate parts 41. Four convex plate parts 41 are arranged between protruding plate parts 22 adjacent to each other in the width direction of the coating head 1, and in an example of FIG. 5, twelve convex plate parts 41 are formed in the shim plate 7.

Each of the convex plate parts 41 protrudes from the extending plate part 21 toward the front side of the coating head 1. However, a protrusion amount of each of the convex plate parts 41 from the extending plate part 21 is smaller than that of each of the protruding plate parts 22 from the extending plate part 21. Then, a position of a protruding end of each of the convex plate parts 41 is not shifted or is rarely shifted with respect to an edge of the manifold 15 on a side near the manifold 13 in the front-back direction of the coating head 1. Between the protruding plate parts 22 adjacent to each other in the width direction of the coating head 1, the four convex plate parts 41 are arranged apart from one another in the width direction of the coating head 1. In addition, between the protruding plate parts 22 adjacent to each other in the width direction of the coating head 1, each of the convex plate parts 41 is arranged apart from the protruding plate parts 22 in the width direction of the coating head 1.

In this modification, the plate thickness part (second plate thickness part) 18 of the shim plate 7 includes relay plate parts 42 instead of the relay plate parts 23. Between the protruding plate parts 22 adjacent to each other in the width direction of the coating head 1, two convex plate parts 41 adjacent to each other in the width direction of the coating head 1 are relayed by a corresponding one of the relay plate parts 42. Further, between the protruding plate parts 22 adjacent to each other in the width direction of the coating head 1, each of the protruding plate parts 22 and a corresponding one of the convex plate parts 41 are relayed by a corresponding one of the relay plate parts 42. Thus, five relay plate parts 42 are formed between the protruding plate parts 22 adjacent to each other in the width direction of the coating head 1, and fifteen relay plate parts 42 are formed in the shim plate 7.

Similarly to the relay plate part 23, each of the relay plate parts 42 is arranged apart from the extending plate part 21 to the front side (arrow X1 side) of the coating head 1, and is arranged apart from the protruding end of each of the protruding plate parts 22 to the back side of the coating head 1. Further, each of the relay plate parts 42 is adjacent both to the manifold (first manifold) 13 on the front side of the coating head 1 and also to the manifold (second manifold) 15 on the back side of the coating head 1. Each of the relay plate parts 42 is a part of the plate thickness part 18. Thus, a gap is not formed or is rarely formed between each of the relay plate parts 42 and the surface 11 of the block 5. Then, a gap is formed between each of the relay plate parts 42 and the surface 12 of the block 6.

In the present modification, the slit (first slit) 31 is formed by the gap between each of the relay plate parts 42 and the surface 12 of the block 6. Thus, five slits 31 are formed between the protruding plate parts 22 adjacent to each other in the width direction of the coating head 1, and fifteen slits 31 are formed in the head main body 2. Also in the present modification, each of the slits 31 is formed adjacent to the manifold (first manifold) 13 on the front side, and the manifold 15 is formed adjacent to each of the slits 31 on the front side. Thus, inside the head main body 2, the manifold 15 communicates with the manifold 13 via the slit 31 therebetween. In addition, between the protruding plate parts 22 adjacent to each other in the width direction of the coating head 1, two slits 31 adjacent to each other in the width direction of the coating head 1 are partitioned by a corresponding one of the convex plate parts 41 of the plate thickness part 17.

Also in the present modification, in each of the slits 31, the plate thickness part (second plate thickness part) 18 of the shim plate 7 is extended between the blocks 5 and 6, whereas in each of the slits 32, the shim plate 7 is not arranged between the blocks 5 and 6. Thus, also in the present modification, a dimension of each of the slits (second slits) 32 along the height direction of the coating head 1 is larger than that of each of the slits (first slits) 31 along the height direction of the coating head 1. That is, the dimension of each of the slits 31 along the height direction of the coating head 1 is smaller than that of each of the slits 32 along the height direction of the coating head 1.

In the head main body 2 of the present modification, one or more fastening parts 43 are formed between the manifolds 13 and 15 instead of the fastening parts 33, and in the example of FIG. 5, etc., a plurality of fastening parts 43 are formed. Each of the fastening parts 43 is one of fastening positions where the blocks 5 and 6 are fastened. At each of the fastening parts 43, a corresponding one of the convex plate parts 41 of the shim plate 7 is sandwiched between the blocks 5 and 6. Each of the fastening parts 43 is located between the manifolds 13 and 15 in the front-back direction of the coating head 1. In addition, each of the fastening parts 43 is not shifted or is rarely shifted with respect to the slit (first slit) 31 in the front-back direction of the coating head 1. In each of the fastening parts 43, the plate thickness part (first plate thickness part) 17 of the shim plate 7 is extended between the blocks 5 and 6, in the same manner as in the fastening part 33 of the above-described embodiment, etc. Thus, in each of the fastening parts 43, a gap is not formed or is rarely formed between each of the blocks 5 and 6 and the shim plate 7.

Also in the present modification, the head main body 2 is provided with two manifolds 13 and 15, and the slit 31 is formed adjacent to the manifold 13 on the front side of the coating head 1. In the coating head 1, the manifold 15 is formed adjacent to the slit 31 on the front side, and the slit 32 is formed adjacent to the manifold 15 on the front side. The dimension of the slit 32 along the height direction of the coating head 1 is larger than that of the slit 31 along the height direction of the coating head 1. Then, one or more fastening parts 43 are formed between the manifolds 13 and 15. With such a configuration, also in the present modification, the same working effect as that in the above-described embodiment, etc. can be exhibited.

Further, in the above-described embodiment, etc., the manifolds 13 and 15 are formed in the block (first block) 5, but in a modification, at least one of the manifolds 13 and 15 may be formed in the block (second block) 6. That is, both the manifolds 13 and 15 may be formed in the block 6, or one of the manifolds 13 and 15 may be formed in the block 5 and the other one of the manifolds 13 and 15 may be formed in the block 6.

In the above-described embodiment, etc., the slit (first slit) 31 is formed by the gap between the plate thickness part (second plate thickness part) 18 of the shim plate 7 and the surface 12 of the block 6, but in a modification, the slit (first slit) 31 may be formed by the gap between the plate thickness part (second plate thickness part) 18 of the shim plate 7 and the surface 11 of the block 5. In this case, in the shim plate 7, a surface facing the side on which the block 6 is located is formed in a state whereby its entirety is located above the same or approximately the same plane. Then, in the shim plate 7, the surface facing the side on which the block 5 is located is formed in a state where the plate thickness part 18 is recessed to the side on which the block 6 is located with respect to the plate thickness part 17. Also in the present modification, a gap is not formed or is rarely formed between each of the blocks 5 and 6 and the plate thickness part 17. However, in the present modification, a gap is not formed or is rarely formed between the block 6 and the plate thickness part 18, but is formed between the block 5 and the plate thickness part 18.

In addition, the number of slits 31 is not particularly limited, provided it is one or more. Similarly, the number of slits 32 is not particularly limited, provided it is one or more. Further, in a modification, the shim plate 7 may not be provided. In this case, the slits 31 and 32 are formed between the blocks 5 and 6 by forming a groove which differs from the manifolds 13 and 15 on either the surface 11 of the block 5 or the surface 12 of the block 6. The groove forming the slit (first slit) 31 and the groove forming the slit (second slit) 32 are formed to be shallower than the manifolds 13 and 15. The groove forming the slit 31 is formed to be shallower than the groove forming the slit 32.

However, in all the modifications, two manifolds 13 and 15 are provided, and the slit 31 is formed adjacent to the manifold 13 on the front side of the coating head 1. Then, in the coating head 1, the manifold 15 is formed adjacent to the slit 31 on the front side, and the slit 32 is formed adjacent to the manifold 15 on the front side. Then, the dimension of the slit 32 along the height direction of the coating head 1 is larger than that of the slit 31 along the height direction of the coating head 1. Thereby, similarly to the above-described embodiment, etc., the coating liquid is uniformly distributed in the width direction of the coating head 1, and deformation of the head main body 2 is suppressed at the ejection port and its vicinity.

According to at least one of these embodiments or examples, inside the head main body, the first slit is formed adjacent to the first manifold on the front side, and the second manifold is formed adjacent to the first slit on the front side. The second slit is formed adjacent to the second manifold on the front side in the head main body, and forms the ejection port to eject the coating liquid from the second manifold to the outside toward the front side. Then, the dimension of the second slit along the height direction is larger than that of the first slit along the height direction. Thereby, it is possible to provide a coating head in which the coating liquid is uniformly distributed in the width direction, and deformation of the head main body is suppressed at the ejection port and its vicinity.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coating head comprising:
a head main body;
a first manifold formed in an inner portion of the head main body;
a first slit formed adjacent to the first manifold on a front side in the inner portion of the head main body;
a second manifold formed adjacent to the first slit on the front side in the inner portion of the head main body, and into which a coating liquid flows from the first manifold through the first slit; and
a second slit formed adjacent to the second manifold on the front side in the head main body, and forming an ejection port to eject the coating liquid from the second manifold to an outside toward the front side, a dimension of the second slit along a height direction intersecting a front-back direction being larger than a dimension of the first slit along the height direction.

2. The coating head according to claim 1, wherein
the head main body includes a first block, and a second block attached to the first block from one side in the height direction,
the first manifold, the first slit, the second manifold, and the second slit are formed between the first block and the second block in the height direction, and
the head main body includes a fastening part to fasten the first block and the second block between the first manifold and the second manifold.

3. The coating head according to claim 2, wherein a dimension of the second manifold along the front-back direction is smaller than a dimension of the first manifold along the front-back direction.

4. The coating head according to claim 2, wherein
the fastening part is formed adjacent to the first slit in a width direction intersecting both the front-back direction and the height direction, and
a dimension of the first slit along the width direction is smaller than a dimension of the second slit along the width direction.

5. The coating head according to claim 4, wherein
the first slit is provided at a plurality of positions arranged along the width direction, and
the fastening part is formed between the first slits adjacent to each other in the width direction.

6. The coating head according to claim 2, further comprising
a shim plate sandwiched between the first block and the second block, wherein
the shim plate includes a first plate thickness part which has a first plate thickness, and a second plate thickness part which has a second plate thickness thinner than the first plate thickness,
in the fastening part, the first plate thickness part is extended between the first block and the second block, and
in the first slit, the second plate thickness part is extended between the first block and the second block.
